(19) United States
(12) Patent Application Publication
(10) Pub. No.: US 2004/0183671 A1
(43) Pub. Date: Sep. 23, 2004

(54) KEY FOB COMMUNICATOR

(76) Inventor: J. Wayne Long, Hobbs, NM (US)

Correspondence Address: TRACY W. DRUCE, ESQ., 1496 EVANS FARM DR, MCLEAN, VA, 22101, US

(21) Appl. No.: 10/707,877

(22) Filed: Jan. 20, 2004

Related U.S. Application Data
(63) Continuation-in-part of application No. 09/534,733, filed on Mar. 27, 2000, now abandoned.

(51) Int. Cl. G08B 1/08

(52) U.S. Cl. 340/539.1; 340/574; 455/404.1

(57) ABSTRACT

An emergency-use key fob communicator that automatically dials an emergency number using a cellular telephone network upon actuation of a single activation button. The key fob communicator is configured to perform only outgoing calls to a single telephone number. The number to be dialed from the key fob communicator may be restricted to preprogrammed assigned emergency numbers or to a single emergency number such as 911. To prevent inadvertent activation, the key fob communicator includes a single activation button shielded by a button guard. The single activation button assigned to dial a programmed number prevents misdialed numbers and the button guard prevents damage to the activation button and inadvertent dialing. The key fob communicator may also be capable of determining the key fob communicator's geolocation and communicating the geolocation to the receiver of an emergency call from the key fob communicator. The key fob communicator includes a sole power source internal to the key fob and is intended to be used only in emergency situations.

### CROSS REFERENCE TO RELATED APPLICATIONS

This application is a Continuation-In-Part of U. S. Non-Provisional application Ser. No. 09/534,733 filed Mar. 27, 2000 and claims the benefit of U.S. Provisional Application No. 60/126,664 filed Mar. 29, 1999 and entitled “Disposable Radiotelephone;” both of which are hereby expressly incorporated by reference, in their entireties, for purposes of disclosure.

### BACKGROUND OF INVENTION

1. Field of the Invention

The present invention relates generally to key fob communication devices, and more specifically to emergency-use communication devices in the form of key fobs.

2. Background of the Invention

Mobile telephones, including those of the cellular and other radio and wireless types, are ubiquitous, offering a wide range of enhancements and features in their basic function of providing full-duplex voice communication. These enhancements often include such features as call waiting, caller ID, text messaging, bill monitoring, ringer volume control, user-programmable memory, and computer network connectivity. Features such as these cost money during each phase of the product's life, i.e., design, manufacture, and use. These enhancements typically require user input through increasingly complex interfaces such as the several keypads included on modern cellular telephones. These full-feature cellular telephones also require sufficient volume and form in the calling units to accommodate the complex interfaces and keypads. For those who carry the calling units for emergency use only, the standard costs of monthly service provider bills and complexities involved in establishing regular cellular telephone service often serve as barriers to “emergency only” callers. The complexities and size of the cellular telephones also make locating and dialing a number under stressful emergency circumstances difficult and time consuming. All of these encumbrances are eliminated with the emergency fob communicator.

### SUMMARY OF INVENTION

The present invention in its several disclosed embodiments alleviates the drawbacks described above with respect to the use of conventionally designed mobile telephones and their standard service plans for emergency cellular phone use, as well as incorporating several additionally beneficial features that especially complement the intended uses of the invention.

The advent of commercially available cellular telephone service has brought mobile communications to persons of all walks of life. The cost of basic cellular telephone service, however, can still be prohibitively high for some consumers, especially for those who would only like to take advantage of the significant safety benefits that mobile telephones afford. Many times, a buyer does not so much wish to use a cellular telephone on a regular basis for day-to-day telephone conversations, but instead desires to have the comfort and knowledge of being capable of making an emergency call should an emergency situation arise in a location away from land-based telephone service. Such buyers also desire an uncomplicated, easily accessible, and conveniently sized communication device, which provides a simple and reliable dialing system under emergency situations. The present invention in its several embodiments provides such a convenient device for satisfying these limited-use or “emergency only” consumers of mobile telephone technology. To meet the challenge of governing the operation of such mobile telephones in ways that permit their limited-use or one-time use, a control device is provided in the cellular telephone that can be programmed based on certain conditions prior to time of sale to the consumer. For instance, voice service on such a system will always be prepaid, but possibly in varying amounts. Therefore, once the purchaser has made the prepayment, the amount of talk-time can be programmed into the cellular telephone, and after that amount of time is utilized, the cellular telephone will become inoperable.

The present invention includes a key fob communicator that may be programmed to dial a single or dedicated telephone number responsively by user actuation of a single activation button. The key fob communicator may be shaped to easily fit in a pocket or purse and provide for the attachment of a key, set of keys, or tether strap. The key fob communicator may also be configured to communicate through cellular telephone networks and may or may not have an active cellular service plan.

The dedicated number of the key fob communicator could be a default or could be programmable. Programming the key fob communicator may be a one-time event or may be repeatedly programmed depending on the intended use of the key fob communication user. In order to function as an “emergency only” communicator, the key fob communicator may be programmed such that an emergency number, i.e., 911, 311, police, or fire, is automatically dialed upon actuation of a single activation button.

The key fob communicator may alternatively be programmed such that other standard numbers are dialed upon actuation of the single activation button. This standard number could be a home number, family member's number, or medical doctor's number. The key fob communicator could provide a user with a dedicated telephone number device capable of limited-use communication in specific situations. By enabling the constraint of a single calling number on the key fob communicator, as well as simplifying its construction, the cost of emergency cellular service may be lowered and the key fob communicator's use strictly controlled. This may be attractive to consumers who wish to have inexpensive emergency outdial-only capabilities for placing calls to one fixed number. For example, parents may wish to provide their children the security and ability to call home in emergencies without providing an expensive and unrestricted full service cellular phone.

The present invention may also include the key fob communicator equipped with a global positioning system (GPS) capable of determining the geographical location (geolocation) of the telephone. Oftentimes a user may not be able to adequately communicate their physical position to an emergency response service, even after voice communication is established. In some situations, the user may be unaware of his or her location, or they may be incapacitated such that they are physically unable to communicate their location. Even in these types of dire situations, if a person is able to actuate the single activation button on the key fob communicator, the geolocation of the key fob communicator may be transmitted to the emergency response service.

In use, this geolocation information will be transmitted in a data stream that is interpreted by the emergency response service to determine the caller's location. It is known, however, that some emergency response services do not have sufficiently sophisticated equipment to “read” such electronic data, even if it is transmitted. However, where possible a benefit may be optionally provided in the present invention for communicating the GPS determined geolocation aurally over the established voice communication as well as orally by the user via an existing landline based using voice synthesis technology that translates the electronic latitude and longitude information supplied by the GPS receiver, and converts the same into aurally comprehensible speech. Given the use of these features, the present invention brings emergency services by way of cellular telephone service within the financial reaches of almost all persons, even those unable or unwilling to purchase conventional, more expensive cellular monthly telephone service.

In more particular aspects, the present invention is directed toward a key fob communicator, including cellular-type mobile telephones and other radio based telephones typically operable within at least one cellular telephone network within a region of the telephone's intended use. All direct charges for use of the telephone, if any, are prepaid, and the telephone's use is limited to a narrow range of function(s) and capabilities.

To prevent misdialing, one embodiment of the telephone includes only a single button input device for causing automated dialing. This feature helps to assure that numbers are not mis-dialed, especially under emergency conditions. The telephone only has the ability to call one number and may be adapted to allow a purchaser to select the preset number, but once set, the number becomes non-changeable by the end user.

The present invention may include a slide guard preventing inadvertent activation of the key fob communicator. The button guard may display a “pop-up” antenna and also act as a switch for the power source, turning the key fob communicator “on” when the button guard is moved, exposing the activation button.

The key fob communicator will additionally include a power source, such as a battery. The battery will be internal to the key fob communicator may include disposable replacement or rechargeable batteries. The key fob communicator will further include an antenna for communicating with a mobile service network and the antenna may be exclusively internal to the key fob. Geographical boundaries outside of which the key fob communicator will not operate and predefined expiring periods of time may also serve as limiting parameters. Further, in order to assure adequate battery power, the key fob communicator may be purchased limited to a single use after which the key fob communicator becomes non-operational.

Alternatively, operation of the key fob communicator may be limited based on the amount of air-time prepaid by the user or number of calls completed using the key fob communicator, all of which are selectable by the consumer at the time of purchase. The key fob communicator has no capability to receive calls, and is further limited only to outgoing calls, to a limited, or small set of callable telephone numbers such as various emergency numbers if there is not one common number such as 911, or the calls could be limited to local numbers only, or through a participating service provider and prepaid at purchase. In any event, each scenario is enabled by a simple programming of the controller described above.

In yet another embodiment, the key fob communicator may be refreshed after the occurrence of an otherwise limiting event for continued but refreshment is always controlled by the issuer of the key fob communicator so that utilization costs can be controlled without risk to the service provider.

The beneficial effects described above apply generally to the exemplary devices and mechanisms disclosed herein for a single for limited use, out-calling-only key fob communicator. The specific structures through which these benefits are delivered will be described in detail herein below.

### BRIEF DESCRIPTION OF DRAWINGS

FIG. 1 is a perspective view of an exemplary embodiment of the key fob communicator with the activation button shown in a guarded condition according to the present invention;

FIG. 2 is a perspective view of the key fob communicator with the activation button shown in an unguarded condition according to the present invention;

FIG. 3 is a back elevational view of the key fob communicator according to the present invention;

FIG. 4 is a side elevational view of the key fob communicator according to the present invention.

FIG. 5 is a perspective view of an alternative embodiment of the key fob communicator with the activation button shown in a guarded condition and the antenna in a retracted configuration; and

FIG. 6 is a perspective view of the key fob communicator of FIG. 5 with the activation button shown in an unguarded condition and the antenna in a deployed configuration according to the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

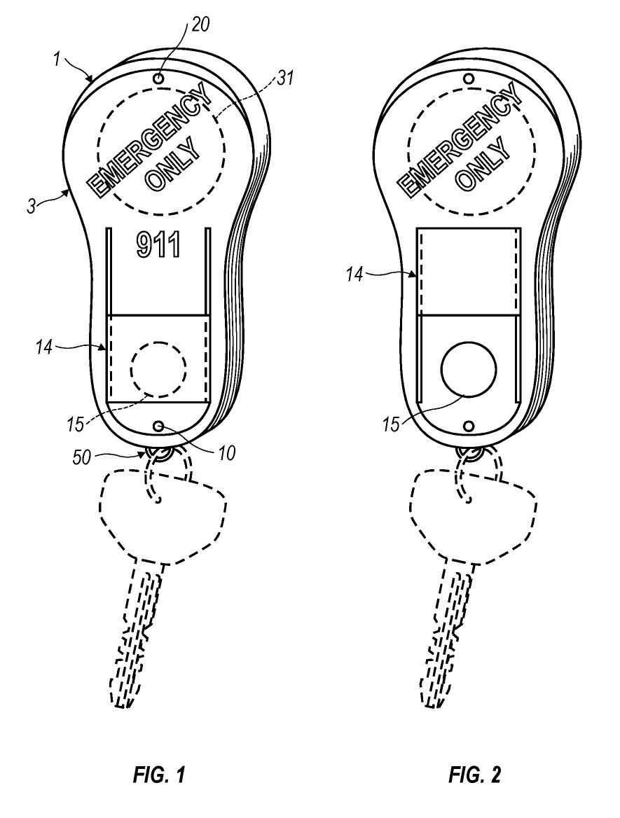

FIG. 1 illustrates an exemplary embodiment of a key fob communicator 1 that includes operational features as prescribed according to the present invention. In this embodiment, the key fob communicator may be configured to call a telephone number using standard communication technologies. Exemplary communication modes for the key fob communicator 1 include cellular service, both digital and analog, and other radio-based modes typically utilized in mobile telephone technologies. For simplicity, the description contained herein refers to the key fob communicator 1 as using cellular telephone communication technology in accommodation of most persons' familiarity with this terminology and easy recognition of the implementation that is described.

In another embodiment, the key fob communicator 1 is operable within at least one cellular telephone network in the region of its intended use. It may be possible that the key fob communicator 1 may operate on multiple cellular telephone networks. However, depending on its use, a service contract for a particular cellular network may be necessary in order to place calls from the key fob communicator 1 to a telephone number.

In one embodiment, the key fob communicator is dedicated exclusively for communication with emergency numbers. In the context of this invention, emergency telephone numbers may include emergency services as well as telephone numbers dialed in emergency situations as defined/specified by the user of the key fob communicator 1 either pre-purchase or pre-manufacture of the device 1. For example, emergency numbers for an elderly person may include fire, police, ambulance services or the telephone number of a family member who lives around the corner. Similarly, emergency numbers for a child or teenager may include any emergency service contacts such as the police, fire, school counselor, or most importantly the child's parents, either home or cellular numbers. All numbers except “911” or “311” would be prepaid at purchase.

In another embodiment, the key fob communicator 1 may be exclusively dedicated for communication with the emergency response telephone number, 911, or its regional equivalent. In this “911 only” embodiment, the key fob communicator 1 may not require a service contract with a cellular service network. In many areas, emergency calls to the number, 911, using a cellular telephone device on a cellular telephone network must be connected regardless of whether or not the cellular telephone device has an active service plan.

In addition to being pre-programmed for calling a single number and actuated by a single button, it is contemplated that the key fob communicator 1 can be further programmed or otherwise adapted to repeatedly dial the called party until reached, or until another precondition is met. An example of such a precondition would be a specified number of redials have been performed without making contact or a prescribed period of redial-time expires without contact being achieved.

FIG. 1 also illustrates the key fob body 3. The key fob body 3 may be shaped and designed to efficiently function as a traditional key fob. In the preferred embodiment of FIG. 1, the key fob body 3 is comprised of two held together parts. On the smaller end of the key fob body 3 is an adaptation defining a receiver, illustrated as attachment ring 50, for connecting a key or tether strap to the key fob communicator 1. While the preferred embodiment includes an attachment ring 50, one of ordinary skill in the art would readily understand that many different mechanisms and attachments might be used to connect to the key fob communicator 1.

The key fob communicator body 3 also functions to stow the micro-circuit communication elements of the key fob communicator 1. In FIG. 1, the key fob communicator body 3 holds the speaker 20 (ear placement speaker), microphone 10 (microphone aperture), activation button 15, and button guard 14. The speaker 20 and microphone 10 may be configured to function as a standard cellular telephone. The button guard 14 is positioned on a set of rails and slidably moves between the shielded position, covering the activation button 15 as shown in FIG. 1, and an unshielded position uncovering the activation button 15. The key fob communicator 1 may also have markings and phrases on the key fob body communicator 3 indicating the purpose and number to be dialed by the key fob communicator 1. In the embodiment of FIG. 1, markings such as “EMERGENCY ONLY” and “911” may serve to inform and alert the user and others to the emergency use and nature of the key fob communicator 1. Such markings may be important if the owner of the key fob communicator 1 is incapacitated or incapable of communicating the emergency use of the key fob communicator 1 to others.

The key fob communicator 1 includes a power source internal to the key fob body 3 and normally in the form of a conventional battery, either permanently included or user replaceable. In a permanent power source embodiment of the key fob communicator 1, the battery could be sized to support a full power single emergency telephone call and the key fob communicator 1 could be considered a one-time disposable emergency communication device.

In another embodiment, the button guard 14 will control the connection between the power source and the key fob communicator 1. The button guard 14 may be configured to place the key fob communicator 1 in a power-off condition when the button cover 14 is in the shielded position. In this power-off condition, the key fob communicator 1 is disabled. The button guard 14 may also be configured to place the key fob communicator 1 in a power-on condition when the button guard 14 is in the unshielded position. In the unshielded position, the key fob communicator 1 may only transmit.

Upon actuation, the activation button 15 enables the key fob communicator 1 to communicate. In all embodiments the key fob communicator is limited to outgoing calls only. The key fob communicator 1 may additionally be limited to outgoing calls for emergency numbers only.

While the activation button 15 as shown in FIG. 1 and FIG. 2 is a push-button type actuation device one of ordinary skill in the art would readily understand that the many different types of devices might be implemented in the key fob communicator 1 to function as the activation button 15. For example, the activation button 15 could be replaced with switches, contact sensors, and other well-known devices and still function within the scope of the present invention.

In one embodiment, the key fob communicator 1 is exclusively limited to dialing outgoing calls to the emergency number 911 upon actuation of the activation button 15. By using one button dialing, the misdialing of the emergency number may be avoided and the activation time for initiating an emergency call may be minimized, which are important considerations in an emergency situation.

FIG. 2 illustrates the button guard 14 in the unshielded position, exposing the activation button 15 and placing the key fob communicator 1 in the power-on condition. In the shielded position and power-off condition, the button guard 14 may function to prevent inadvertent call initiation, power supply depletion or damage to the activation button 15. In FIG. 2, the button guard 14 is slidably attached to the key fob communicator 1 however the button guard 14 may also be attached to the key fob body 3 in other suitable ways as long as the button guard 14 requires positive user input, e.g., sliding, rotating, pivoting, disengagement, separation, breakage, or the like, before exposing or otherwise enabling the activation button 15 to be actuated. Likewise, button guards in the form of flip covers, destructible covers, removable covers, and other equivalent devices may be used to guard the activation button 15 from accidental activation or damage.

In the illustrated embodiment of FIG. 2, the activation button 15 takes the form of a push-button actuator and the button guard 14 is a sliding cover that is movable by the user from a shielded position over the activation button 15 to an unshielded position adjacent to the activation button 15. This sliding action is easily performed by the user through positive user (thumb) input and manual engagement of an exposed top surface of the button guard 14, but the resistance offered by the button guard 14 to sliding is sufficiently strong such that the button guard 14 will not slide to the unshielded position by mere abutment with other objects such as those carried in a purse or pocket.

In an alternative embodiment, the key fob communicator 1 includes a Global Positioning System (GPS) receiver. The GPS receiver is operable in cooperation with the well-known GPS satellite system to determine geolocation of the activated key fob communicator 1, and consequently the location of the user. Additionally, the GPS receiver may be interfaced with the key fob communicator's 1 communication system in such a manner as to communicate the geolocation of the key fob communicator 1 to the receiver of a call from the key fob communicator 1. The geolocation communication may be in the form of a transmission from the key fob communicator 1 either automatically, or in response to a request from a dialed party, such as 911 emergency response personnel. The key fob communicator 1 may be operative to respond automatically to requests with the key fob communicator's 1 geolocation. Preferably, the geolocation will be sent as a data stream to be interpreted by the system at the dialed number. If the key fob communicator 1 does not have a GPS receiver, or if the geolocation is unavailable or indeterminable, the key fob communicator 1 may be configured to respond to requests for geolocation with responses indicating the condition of the key fob communicator 1, such as “no geolocation available”.

It is contemplated that some emergency response systems will not be able to process geolocation data and it would therefore not be useable by them. In the embodiment mentioned above in which the geolocation information is transmitted automatically, the information may also be transmitted in “oral format” so that this important information may be discussed with an attendant of the emergency response system, regardless of the system's capabilities, i.e. the user will verbally tell the attendant a location.

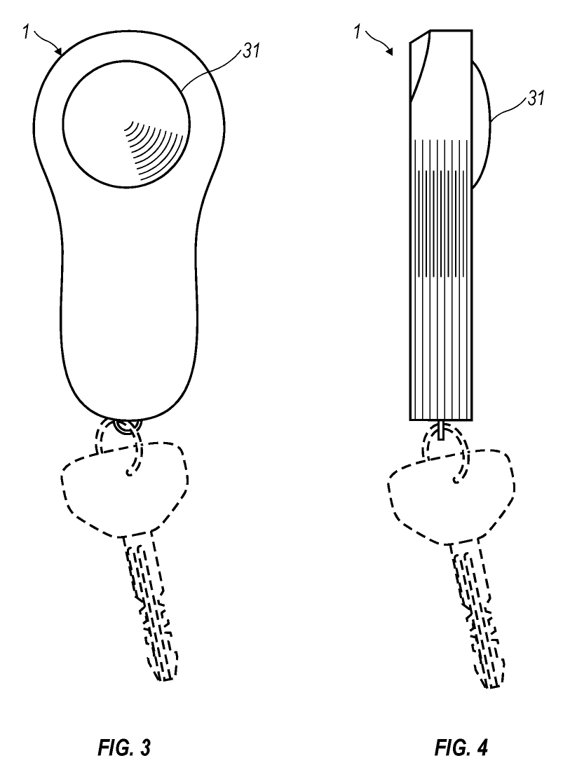

FIG. 3 and FIG. 4 illustrate the back and side view respectively of the key fob body 3. Also shown are the speaker 20 and the key attachment 50. In the embodiment shown in FIG. 3 and FIG. 4, the key fob body 3 holds an antenna 31 (flat dome style antenna) configured to support cellular communication between the cellular network and the key fob communicator 1. In the shown embodiment, the antenna is exclusively within the key fob body 3 allowing the key fob body 3 to easily and comfortably fit within a pocket or purse. It is contemplated that the antenna may also be incorporated into the key fob body 3 in a protrusion-free manner, or extend from the key fob body 3 so long as the antenna functions to connect the key fob communicator 1 to a cellular network.

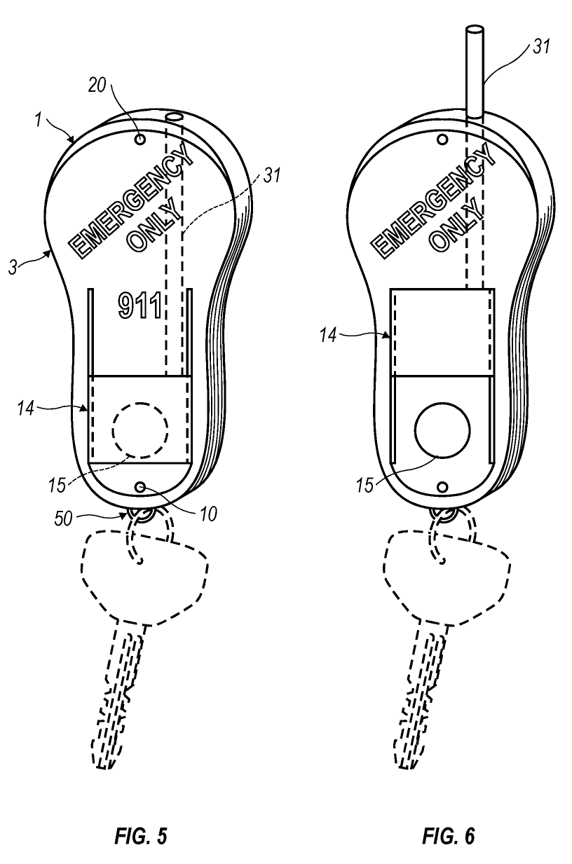

FIGS. 5 and 6 illustrate an embodiment in which the antenna 31 is of an elongate, linear configuration, and which is deployed (FIG. 6) when the sliding button cover 14 is in an activating configuration with the button exposed and is retracted within the key fob body 3 (FIG. 5) when the sliding button cover 14 is in a deactivating configuration with the button covered.

FIGS. 1-4 also serve to illustrate the keypad free configuration of the key fob communicator 1. The one activation button configuration aids the user in quick, efficient, and simple dialing of emergency numbers without having to manipulate complex and typically small keypads. Automatic activation (power-up) of the communicator preferably occurs upon moving the button guard 14 to the unshielded position and thereby enabling manual actuation of the communication initiation button 15 further enhancing the safety features of the key fob communicator 1 and allows a user to reliably dial an emergency number under emergency situations.

In yet another alternative embodiment, the key fob communicator 1 includes a power source which is readily replaceable. As with the earlier described embodiments, the key fob communicator 1 is operable within at least one radiotelephone network in the region of its intended use and, if not used exclusively for emergency calls, direct charges for use are prepaid. Key fob communicator 1 is characterized by a set of limiting events including: the end of a preset number of completed calls; the expiration of a preset amount of airtime; and/or the occurrence of a preset point in time. The key fob communicator 1 is of no operational use to an end user after occurrence of the earliest limiting event unless and until prepaid use is refreshed. In this alternate embodiment, the key fob communicator remains disposable or refreshable at the user's discretion, but interface with the provider of the key fob communicator 1 would be required for refreshment. In this sense, operation of the key fob communicator 1 may still be limited, without requiring that it be disposable.

All direct charges for use of the key fob communicator 1 prepaid. Further, operation of the key fob communicator 1 may be characterized, for example, by a set of limiting events or conditions that may include: the end of the elapsed operational life of the batteries; the end of a preset number of completed calls; the expiration of a preset amount of air time; and/or the occurrence of a preset point in time. In a particularly preferred embodiment, the key fob communicator 1 is of no operational use to an end user after the earliest occurrence of any one of the limiting events.

In an alternative embodiment, in addition to providing full-duplex voice communication, the key fob communicator 1 may also receive requests for information from a system with which the key fob communicator 1 is communicating but only after a call has been initiated and established by the user. Examples include the called system requests the status of a limiting condition for the key fob communicator 1 operation such as how much longer can the user remain connected to the system and the key fob communicator responds with appropriate data such as “5 minutes of air time remaining.” The response from the key fob communicator 1 is transmitted as a data stream to be interpreted by the requesting system at the dialed number. This type of capability is particularly important in emergency situations where such data may be interpreted when determining proper responses to be made by emergency care providers.

INDUSTRIAL APPLICABILITY: The present invention finds applicability in the portable communications industries, National Homeland Security, public defense, domestic defense, and especially in the personal emergency communication device industries.

1. A key fob communicator comprising:
a key fob body;
a receiver configured to accept connection of a key to the key fob body;
a single activation button located on the key fob body; and
said key fob communicator being operable within at least one mobile telephone network upon actuation of the single activation button.

2. A key fob communicator as recited in claim 1, further comprising a button guard located on the key fob body, the button guard protectively shielding the single activation button from accidental actuation.

3. A key fob communicator as recited in claim 2, wherein the button guard is movable from a shielded position covering the activation button to an unshielded position uncovering the activation button.

4. A key fob communicator as recited in claim 3, wherein said key fob communicator is in a power-off configuration when the button guard is in the shielded position and the key fob communicator is in a power-on configuration when the button guard is in the unshielded position.

5. A key fob communicator as recited in claim 3, wherein the button guard is slidably mounted on the key fob body.

6. A key fob communicator as recited in claim 1, wherein said key fob communicator is limited to outgoing calls.

7. A key fob communicator as recited in claim 1, wherein said key fob communicator is exclusively operable for communication with a single preset number.

8. A key fob communicator as recited in claim 7, wherein the single preset number is an emergency number.

9. A key fob communicator as recited in claim 8, wherein in the emergency number is one of 911 and 311.

10. A key fob communicator as recited in claim 1, further comprising a global positioning system (GPS) receiver adapted for cooperation with GPS satellites for determining the geolocation of the activated key fob communicator.

11. A key fob communicator as recited in claim 10, wherein the key fob communicator is configured to transmit the geolocation of the activated key fob communicator to the receiver of an outgoing call.

12. A key fob communicator as recited in claim 1, wherein the one button communicator is keypad free.

13. A key fob communicator as recited in claim 1, further comprising an antenna configured to operate with said key fob communicator.

14. A key fob communicator as recited in claim 13, wherein said antenna is of linear configuration and is translationally installed upon the key fob communicator, said antenna is further interconnected with a slide-style button guard so that the antenna is deployed to a position substantially outside the key fob body from a position substantially inside the key fob body when a sliding button guard is moved to an activated configuration from a shielding configuration.

15. A key fob communicator as recited in claim 13, wherein the key fob body is essentially protrusion-free from the antenna.

16. A key fob communicator as recited in claim 15, wherein the antenna is exclusively internally located within the key fob body.

17. A key fob communicator as recited in claim 1, wherein the key fob communicator is configured to use replaceable batteries.
